(19) United States
(12) Patent Application Publication
(10) Pub. No.: US 2014/0025674 A1
(43) Pub. Date: Jan. 23, 2014

(54) User-Specific Search Result Re-ranking

(71) Applicants: Barry A. Kritt, Raleigh, NC (US); Sarbajit K. Rakshit, Kolkata (IN)

(72) Inventors: Barry A. Kritt, Raleigh, NC (US); Sarbajit K. Rakshit, Kolkata (IN)

(73) Assignee: INTERNATIONAL BUSINESS MACHINES CORPORATION, Armonk, NY (US)

(21) Appl. No.: 13/553,809

(22) Filed: Jul. 19, 2012

(51) Int. Cl. G06F 17/30

(52) U.S. Cl. 707/732; 707/E17.014

(57) ABSTRACT

A search result is re-ranked/re-ordered in a user-specific manner, where the search result comprises an ordered sequence of identifications of a plurality of network-accessible documents that match a search query, based on a model corresponding to a user who will view the search result. The model comprises keywords and relationships among them, according to how the user perceives relationships among the keywords. The re-ranking comprises changing an order of at least one of the identified plurality of network-accessible documents within the ordered sequence, responsive to comparing ones of the keywords in the model to the identifications of network-accessible documents. The search result is then rendered, as re-ranked, for the user. The relationships may have an associated bond strength, and the re-ranking comprises changing the order accordingly. Keywords from the model are preferably used to group the identifications during the re-ranking.

### BACKGROUND

The present invention relates to computing systems, and deals more particularly with searches that use computing systems to locate network-accessible documents. Still more particularly, the present invention relates to programmatically re-ranking results for a search query in a user-specific manner.

Performing searches to locate network-accessible documents (such as Web pages having content on a searched-for topic) is a very common experience for today's computer users. Users may perform such searches many times in a given day, whether searching for information related to their job or for personal reasons. A search engine uses terms provided by the user as a search query and locates information of interest to provide to the user as a result of the search query. The number of different network-accessible documents located as the result for a given search query may range from a very small number (including zero) to many thousands of different documents.

### BRIEF SUMMARY

The present invention is directed to user-specific search result re-ranking. In one aspect, this comprises: responsive to receiving a search query from a user, performing a search of network-accessible documents using the search query to obtain a search result, the search result comprising an ordered sequence of identifications of a plurality of the network-accessible documents that match the search query; and programmatically customizing the search result using a user-specific model for the user, the user-specific model comprising a set of keywords and relationships among the keywords. Programmatically customizing the search result further comprises: locating, in the model, a selected one of the keywords that corresponds to the search query; obtaining, from the model, each of at least one of the keywords that has a relationship with the located keyword; comparing each obtained keyword to the identifications to locate any of the identifications which match the each obtained keyword; re-ranking the search result, based on the comparing, by changing an order of at least one of the identifications within the ordered sequence; and rendering, for the user, the search result as re-ranked.

Embodiments of these and other aspects of the present invention may be provided as methods, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

### BRIEF DESCRIPTION OF THE SEVERAL VIEWS OF THE DRAWINGS

The present invention will be described with reference to the following drawings, in which like reference numbers denote the same element throughout.

FIGS. 1 and 2 depict examples illustrating how a particular person may associate various topics in his or her mind, and how this varies among different people;

FIG. 3 depicts a flowchart illustrating creation of a data model for use by an embodiment of the present invention;

FIG. 4 presents a flowchart depicting logic which may be used for re-ranking results of a search, according to an embodiment of the present invention;

FIGS. 5A-5D illustrate how a search result may be presented after re-ranking, and how a user may interact with the re-ranked search results, according to an embodiment of the present invention;

FIG. 6 depicts a data processing system suitable for storing and/or executing program code; and

FIG. 7 depicts a representative networking environment in which one or more embodiments of the present invention may be used.

### DETAILED DESCRIPTION

The present invention is directed to ordering a search result, and more particularly to re-ranking (e.g., changing the ordering of) a search result in a user-specific manner. Different users have different interests and different patterns of thinking, and accordingly, may have different expectations as to what should be returned as the result of a particular search query or how that result would be most beneficially presented for the user.

Humans store a vast amount of information in their memories, and this stored information may generally be described as pertaining to one or more topics, where the topics are related in various ways. As will be obvious, different people remember information on different topics, with different relationships among those topics. (For ease of reference, the term “event” is used herein when referring to the remembered information, although the information might be remembered for reasons other than occurrence of an event.) For a particular person, recalling some event characterized as pertaining to a particular topic will automatically bring other sub-events or related events to mind. For example, the person may recall additional details of the event, which may be characterized as pertaining to different topics; in addition or instead, the person may recall different events which may be characterized as pertaining to the same topic.

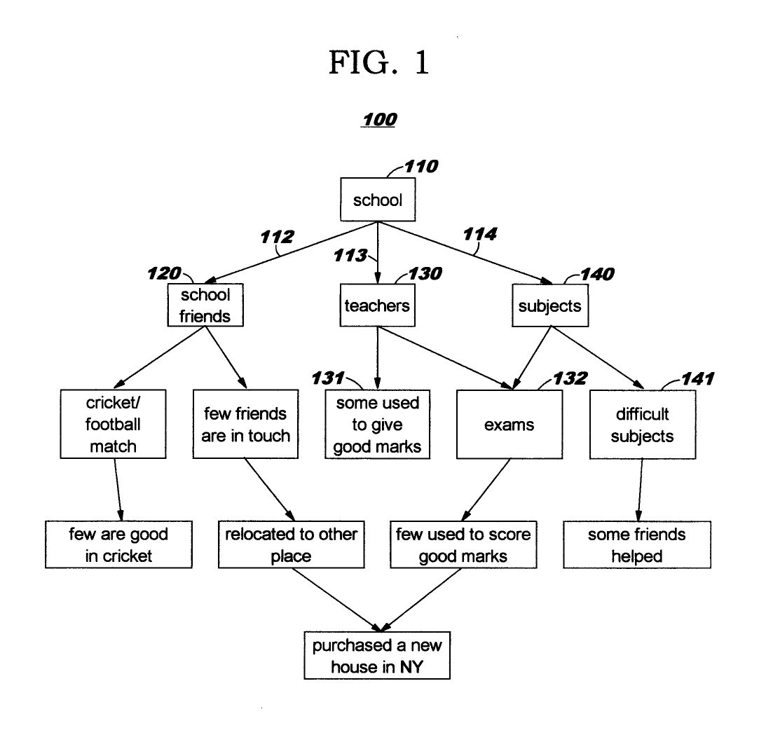

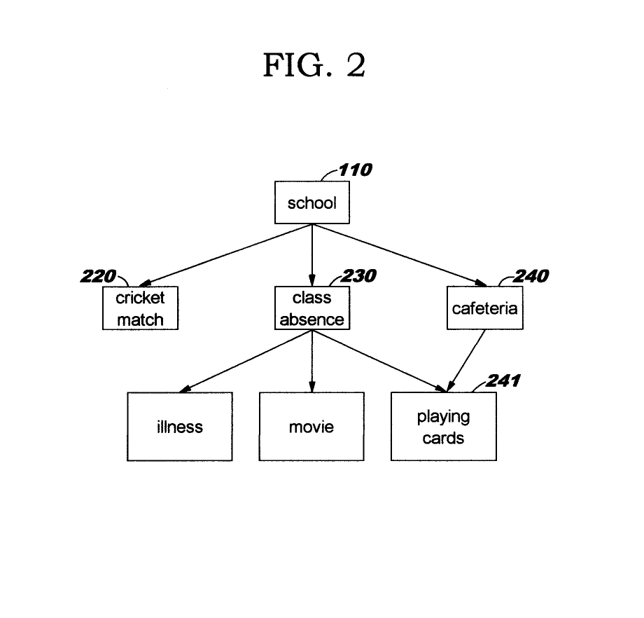

FIGS. 1 and 2 are provided by way of illustrating how a particular person may associate various topics in his or her mind, and how this varies among different people. As shown in FIG. 1, suppose a person named “User 1” thinks about the topic “school” 110. In turn, this may cause User 1 to automatically think of related topics “school friends” 120, “teachers” 130, and/or “subjects” 140. Once the user begins to think about a related topic, he or she may then be reminded of other related topics. For example, thinking about “teachers” 130 may cause User 1 to automatically think about those who gave good marks/grades 131 and/or the exams 132 that were given by teachers. (As will be obvious, the examples provided herein are by way of illustration but not of limitation.)

In contrast to the topics and relationships illustrated in FIG. 1, suppose a person named “User 2” thinks about the same topic “school” 110. This may cause User 2 to automatically think of related topics “cricket match” 220, “class absence” 230, and/or “cafeteria” 240. Once User 2 begins to think about the related topic “cafeteria” 240, he or she may then be automatically reminded of another related topic “playing cards” 241, for example.

As can be seen with reference to FIGS. 1 and 2, the remembered topics are user-specific, and the relationships among topics is also user-specific, and the topics and relationships may generally be affected by the events experienced by each person and the memories that are stored in response. The graphs shown in FIGS. 1 and 2 may be generally characterized as describing a person's individual pattern of thinking By creating a model of the topics and relationships among them for a person, predictions may be made about what information is of interest to this person. For example, a prediction might be made that User 1 is interested in exams 132 if it is known that User 1 is following the path 110, 130 of FIG. 1. Accordingly, an embodiment of the present invention leverages this model when presenting search results to a user who is searching for network-accessible documents.

As is well known, when a user performs a search of network-accessible documents (such as Web pages), results of the search are typically displayed as a list of descriptive information pertaining to each of a plurality of documents matching the search query and a corresponding selectable link with which each of these documents can be accessed (although it is noted that in some cases, there may be zero or one search result for a particular search query). The selectable links are typically presented as Uniform Resource Locators (“URLs”) and the corresponding descriptive information is aimed at guiding the user in choosing which of the links to access. The search results are typically ordered according to an expected relevance of each located document to the search query, where the relevance is judged by how closely terms of the search query match terms associated with each located document. These concepts are readily understood by those of ordinary skill in the art. As is also readily understood, a user who is viewing the search results might select one or more of the selectable links, in turn, to peruse selected ones of the documents that are accessible from the selectable links

An embodiment of the present invention is directed to re-ranking a set of search results (also referred to herein as “a search result” or “search results”) into a new order and displaying the re-ranked search results in the new order, where the re-ranking is performed in view of a user-specific model that represents relationships among topics. According to an embodiment of the present invention, the topics are represented in the model by keywords, and the model is specific to the user who will view the displayed search results. Therefore, for the same set of search results, different users will see the results in a different order. Different users may therefore effectively see different search results for the same query. For example, when the search results exceed the viewable display space, then search results presented to a first user as the first page of results might not be viewable as the first page of results shown to a second user because those results could appear in a later, non-displayed portion of the results initially presented to the second user.

The user-specific model is preferably constructed using data mining techniques, where the data mining may use as input one or more of the following information sources: files stored on the user's computing device; files stored remotely for the user; e-mail and instant message content stored for the user; video and/or image files stored for the user; content shared by the user in various social networking channels; and so forth. The data mining technique that determines the keywords and relationships that form the model may comprise, for example, association rule or decision tree text mining. Data mining techniques are known in the art, and a detailed discussion thereof is therefore not deemed necessary herein.

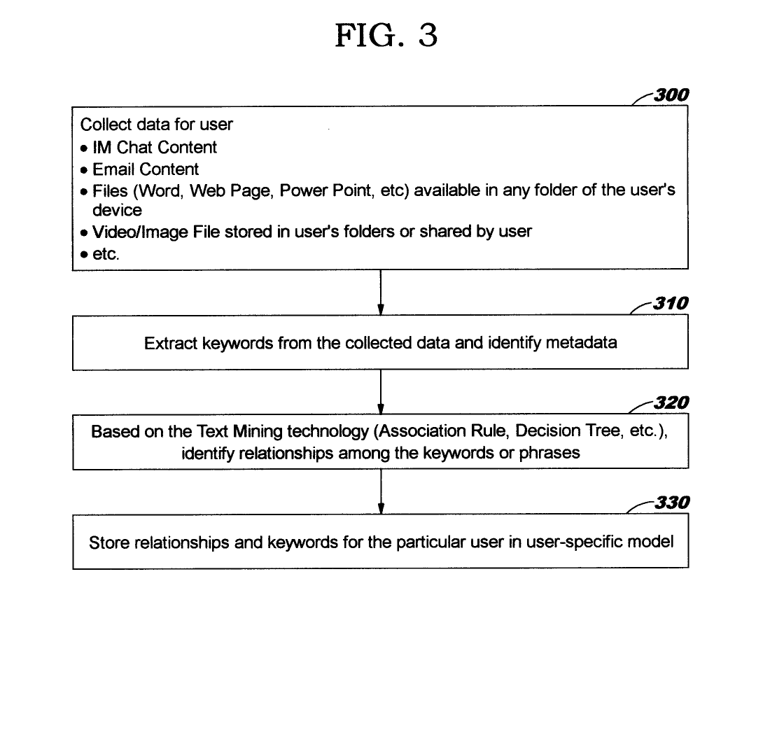

FIG. 3 depicts a flowchart illustrating creation of a data model for use by an embodiment of the present invention. As shown therein, data in various forms is collected (Block 300) for a particular user. This data may be stored on the user's local computer and/or on remote storage which is associated with the user. Keywords and metadata are extracted from the stored data or some portion thereof (Block 310). The metadata may comprise, for example, data and time stamps of files and messages; content type information; content author information; links among files and messages; and so forth. The data mining operation determines relationships among the extracted keywords, in view of the metadata (Block 320). Preferably, the strength of a bond between the keywords in each relationship is also determined, and this bond strength value is associated with the corresponding relationship. For example, if User 1 is much more likely to think of teachers 130 when thinking about school 110, as contrasted to thinking about school friends 120, then the bond strength of relationship 113 is higher than the bond strength of relationship 112.

The keywords and relationships are then stored (Block 330) as a model, which may be in storage local to the user's computer or in remote storage which is associated with the user. Examples of the models for two hypothetical users were discussed above with reference to FIGS. 1 and 2.

The data model may be periodically updated by repeating the processing shown in FIG. 3, thereby reflecting up-to-date information for the user. This periodic updating may be triggered in various ways, such as: based upon a particular period of time elapsing since the model was last updated; based upon a predetermined amount of new data being collected; in response to an explicit request of a user; and so forth.

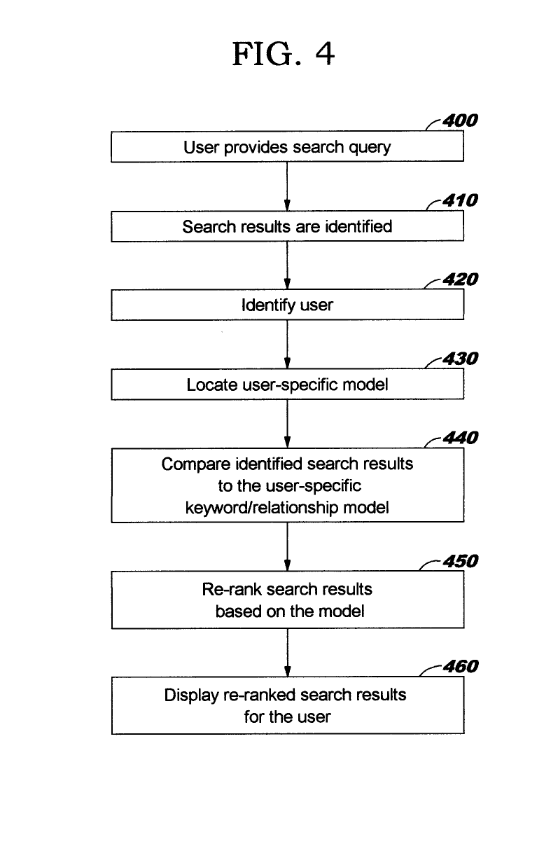

FIG. 4 presents a flowchart depicting logic which may be used for re-ranking results of a search, according to an embodiment of the present invention. The user provides a search query comprising one or more terms (Block 400). The search query is then provided to a search engine, which locates search results comprising a set of documents that match the query (Block 410). As noted earlier, the search results include descriptive information and a corresponding selectable link for each located document, where any of these selectable links can be activated to retrieve a corresponding document for the user. (Note that while discussions herein refer primarily to “displaying” information to a user, this is by way of illustration and not of limitation. An embodiment of the present invention may use a different type of rendering, such as an audible rendering, and such alternatives are within the scope of the present invention.)

An identification is obtained of the user of the computing device on which the results will be displayed (Block 420), if this identification is not already available. Obtaining the identification may comprise accessing stored information on the computing device, such as the user's log-on name or other identifying information. The user identification is preferably used to locate the user-specific model (Block 430). In an alternative approach, the functionality of Blocks 420 and 430 may be combined by obtaining a model which is associated with the computing device on which the search query is received.

The terms of the search query are then compared to the keyword/relationship model for the user (Block 440), and the search results are re-ranked (Block 450) in view of this comparison. The re-ranked search results are then displayed (Block 460) for the user. (Note that it may happen, in some cases, that the comparison of the search results to the user-specific model indicates that the original order of the search results is the preferred order for this user, although this may be a rare occurrence.)

Suppose, by way of illustrating the processing in FIG. 4, that User 1 entered the term “school” as a search query at Block 400. When Block 440 compares this term to the user-specific model 100 of FIG. 1, a match will be found to keyword 110, which in turn identifies 3 related keywords 120, 130, 140. Accordingly, the re-ranking performed at Block 450 preferably comprises determining which, if any, of the documents in the search result match both “school” 110 and “school friends” 120 (or, more particularly, which documents match both “school” and “friends”, since keyword 120 includes keyword 110 in this example); which documents, if any, match both “school” 110 and “teachers” 130; and which documents, if any, match both “school” 110 and “subjects” 130. The documents matching each set of associated keywords (e.g., matching both “school” 110 and “teachers” 130) may then be grouped together. (Note that the grouping may comprise a logical grouping, for example by storing pointers to documents that belong to a particular group or otherwise identifying the group members.) Block 450 also preferably comprises determining the bond strength of each of the relationships 112, 113, 114, and then ordering the determined groups of results according to the corresponding relationship bond strength.

Assume, for purposes of illustration, that relationship 114 has the highest bond strength value, followed by relationship 113 and then relationship 112. This is an indication that User 1 has a stronger mental association between the keywords “school” and “subjects” than between the keywords “school” and “teachers”, which in turn is a stronger association than between the keywords “school” and “school friends”. Accordingly, an embodiment of the present invention uses the bond strength values to present the search results to the user according to the strength of this user's mental associations, thereby automatically tailoring the search results in a user-specific manner.

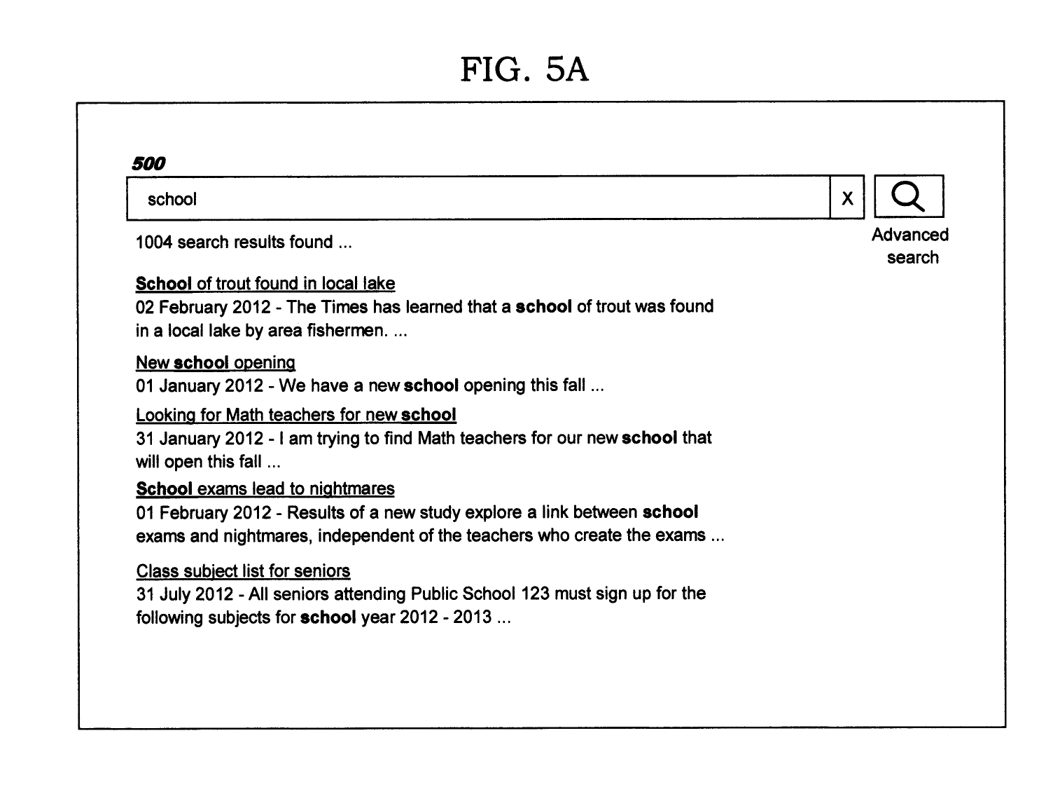

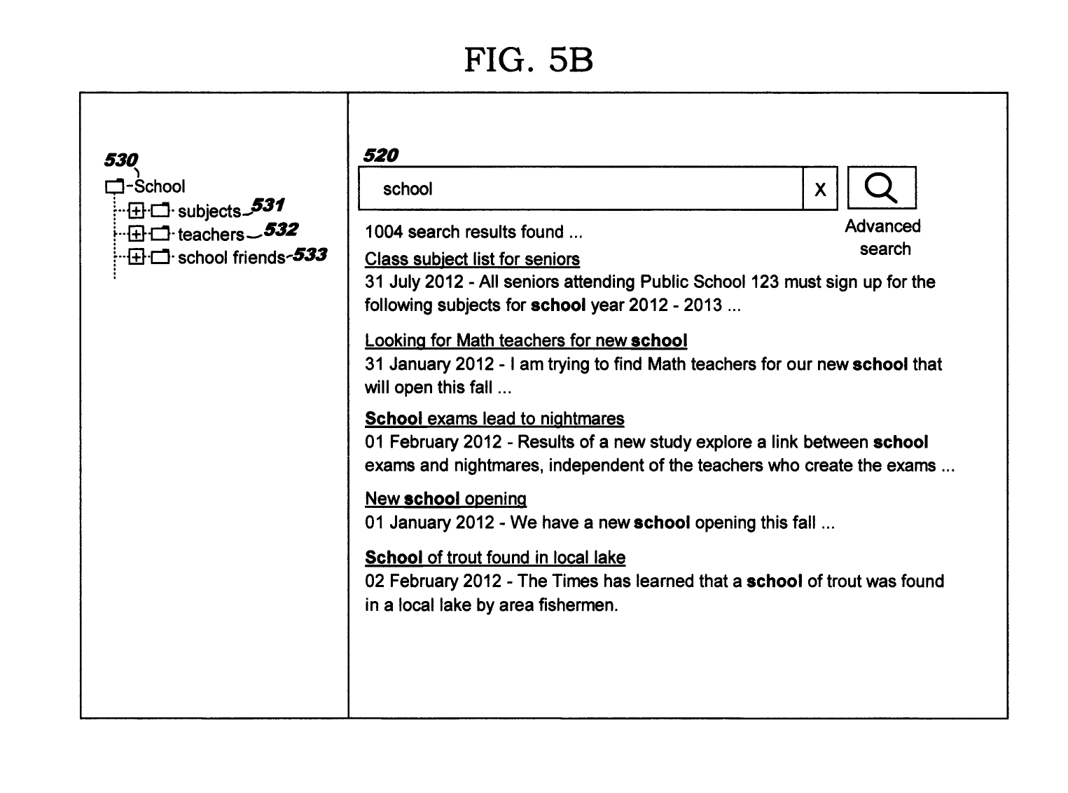

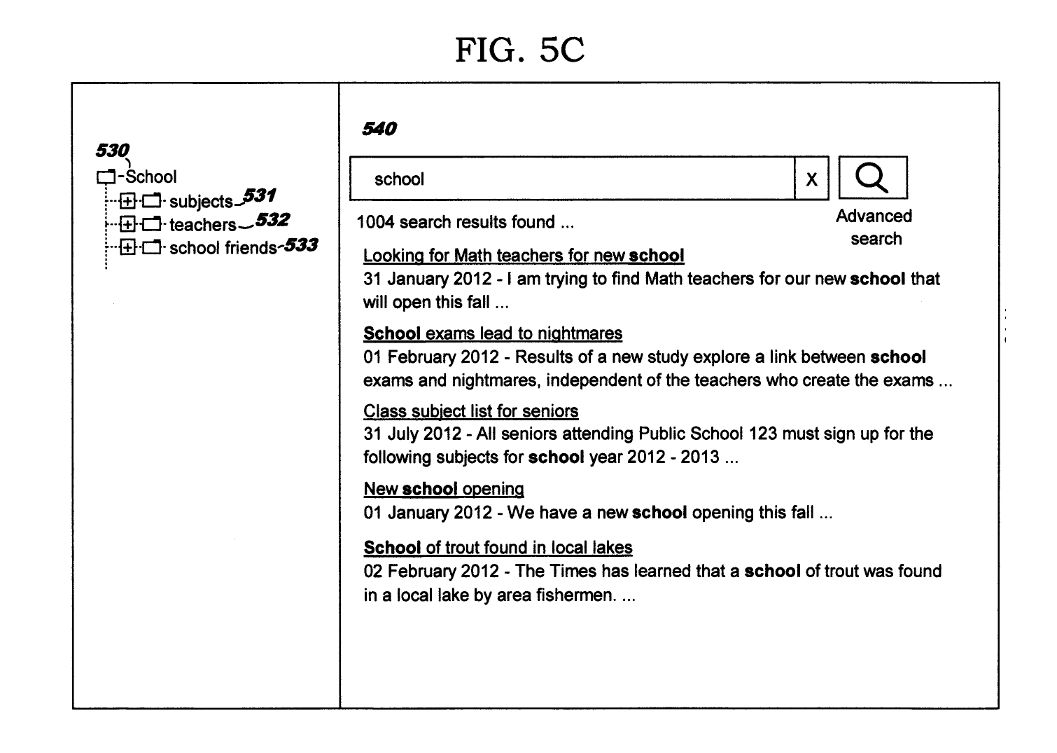

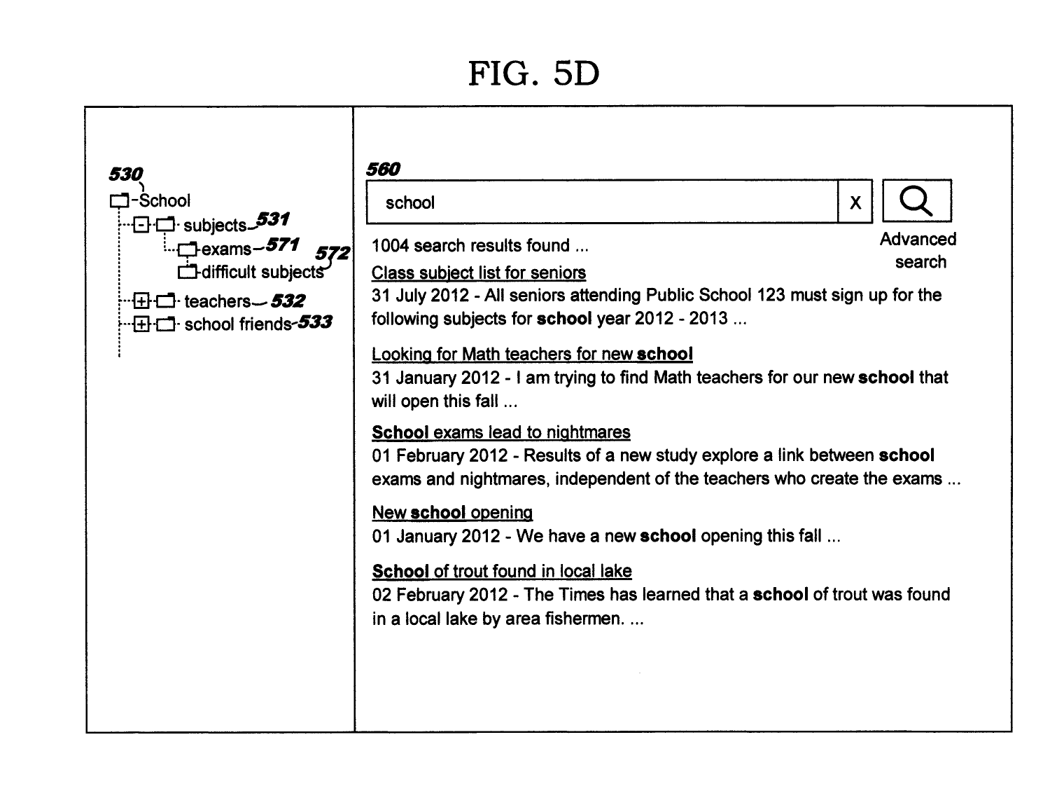

FIGS. 5A-5D illustrate how a search result may be presented after re-ranking, and how a user may interact with the re-ranked search results, according to an embodiment of the present invention. (Note that a preferred embodiment of the present invention does not remove documents from the search results, and therefore all users would find the same collection of documents upon paging through all pages of the search results display, although presented in a different order.) The example display 500 in FIG. 5A shows how the search results might be ordered according to a prior art search process (and note that FIG. 5A is shown for illustration only: an embodiment of the present invention does not actually display the search result in its original order as shown in display 500). The example display 520 in FIG. 5B, by contrast, shows how the re-ranked search results are presented according to an embodiment of the present invention. Notably, the ordering of the individual linked documents (where the term “linked document” refers to the descriptive information and corresponding selectable link for a located document) has been changed by re-ranking thereof, based on the user-specific model and the keywords, relationships, and bond strength values represented therein (preferably, according to successively decreasing magnitude of the bond strength values).

FIG. 5B also illustrates an added graphic 530 which is not present in display 500 of FIG. 5A, and which is provided by an embodiment of the present invention. Graphic 530 gives the user a high-level view of the grouping of the re-ranked search results. In the example display 520, the graphic 530 corresponds to the two topmost levels of the hierarchy in model 100 in FIG. 1 and contains an element corresponding to each keyword in the topmost levels. In the general case, the order of the elements in the graphic does not necessarily match the order of the corresponding keywords in the model: instead, the elements are ordered according to decreasing magnitude of the bond strength of their corresponding relationships in the model. Accordingly, in the example of FIG. 5B, the elements 531, 532, 533 correspond to keywords 140, 130, 120 in model 100.

The user may select (for example, by mouse click) one of the elements 531, 532, 533 of graphic 530 from display 520, and this enables the user to traverse the search results according to the hierarchy of the user-specific model. In response to the user's selection, the search results of display 520 will be updated to show individual linked documents of the selected group (as grouped according to the processing of Block 450 of FIG. 4). Suppose, by way of example, that the user selects element 532. In response, the example search results illustrated by display 540 of FIG. 5C are presented, where these search results comprise linked documents that match both “school” 110 (i.e., the user's original search query) and related keyword “teachers” 130.

Graphic 530 also preferably indicates, by use of a “+” symbol (or similar indicator, equivalently), when a level of the grouping contains subgroups. The user may select this “+” symbol for a particular element 531-533 to expand the selected element to thereby display its subgroups. Suppose, by way of example, that the user selects the “+” symbol of element 531 from FIG. 5B. In response, as shown by FIG. 5D, graphic 530 is preferably redisplayed with expanded detail at 531 to depict the keywords of the corresponding subgroup. In the example, this expanded detail comprises elements 571, 572 corresponding to the keywords “exams” 132 and “difficult subjects” 141 which are found in the next level of the hierarchy of model 100 of FIG. 1—that is, the child nodes of “subjects” 140. The user may, in turn, select one of the elements 571, 572 in the expanded detail to update the search results display (not shown in FIGS. 5A-5D) with linked documents corresponding to that subgroup. For example, selecting element 571 of FIG. 5D would update the search result display to show the linked documents that match “school” 110, “subjects” 140, and “exams” 132.

Optionally, user-specific priority values may be used to further customize the user-specific model. Priority may be set, for example, for particular types of documents, for particular document creators, and/or using other criteria. For example, a particular user may configure his or her system to give priority to self-created documents (including, by way of example, chat messages and e-mail messages sent by this user), such that documents created by this user are weighted more heavily when computing bond strength for relationships, as compared to documents created by someone else. In this example, the higher priority for user-created documents will generally cause the model to more accurately reflect the user's own perception of relationships among keywords, which in turn will generally lead to a better outcome when re-ranking search results for the user.

As can be seen from the above discussion, an embodiment of the present invention provides for re-ranking a search result in a user-specific manner, and may therefore present a user with a more user-directed and/or relevant set of selectable documents within a set of search results, as compared to using known techniques.

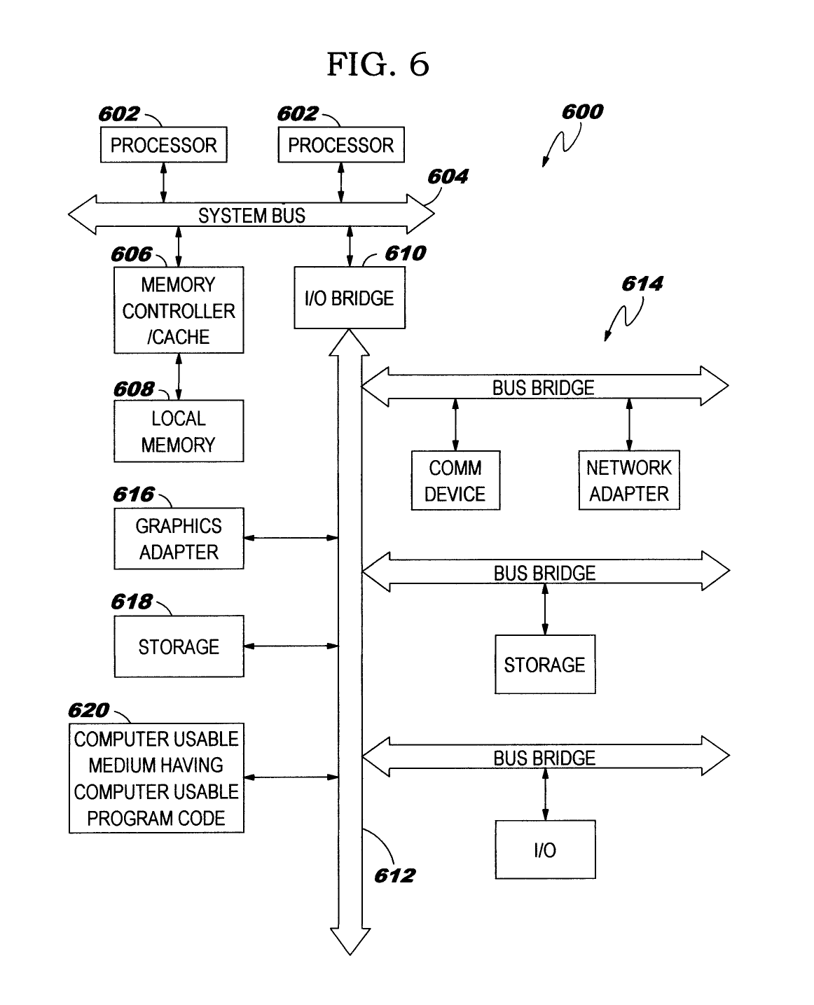

Referring now to FIG. 6, a block diagram of a data processing system is depicted in accordance with the present invention. Data processing system 600, such as one of the processing devices described herein, may comprise a symmetric multiprocessor (“SMP”) system or other configuration including a plurality of processors 602 connected to system bus 604. Alternatively, a single processor 602 may be employed. Also connected to system bus 604 is memory controller/cache 606, which provides an interface to local memory 608. An I/O bridge 610 is connected to the system bus 604 and provides an interface to an I/O bus 612. The I/O bus may be utilized to support one or more buses 614 and corresponding devices, such as bus bridges, input output devices (“I/O” devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 616, storage 618, and a computer usable storage medium 620 having computer usable program code embodied thereon. The computer usable program code may be executed to execute any aspect of the present invention, as have been described herein.

The data processing system depicted in FIG. 6 may be, for example, an IBM System p® system, a product of International Business Machines Corporation in Armonk, N.Y., running the Advanced Interactive Executive (AIX®) operating system. An object-oriented programming system such as Java may run in conjunction with the operating system and provides calls to the operating system from Java® programs or applications executing on data processing system. (“System p” and “AIX” are registered trademarks of International Business Machines Corporation in the United States, other countries, or both. “Java” is a registered trademark of Oracle America, Inc., in the United States, other countries, or both.)

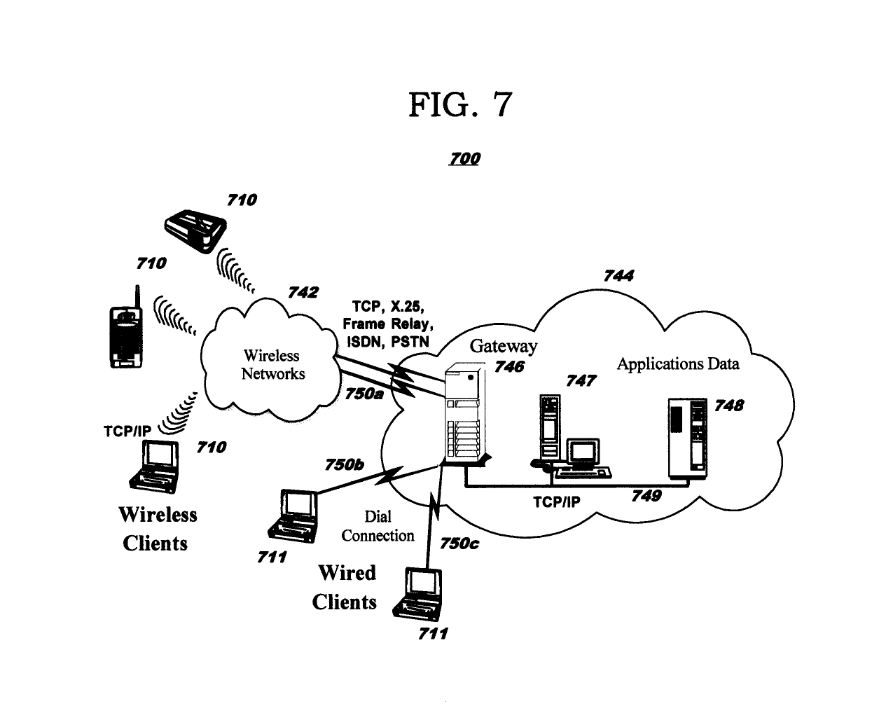

FIG. 7 illustrates a data processing network environment 700 in which the present invention may be practiced. The data processing network 700 may include a plurality of individual networks, such as wireless network 742 and wired network 744. A plurality of wireless devices 710 may communicate over wireless network 742, and a plurality of wired devices, shown in the figure (by way of illustration) as workstations 711, may communicate over network 744. Additionally, as those skilled in the art will appreciate, one or more local area networks (“LANs”) may be included (not shown), where a LAN may comprise a plurality of devices coupled to a host processor.

Still referring to FIG. 7, the networks 742 and 744 may also include mainframe computers or servers, such as a gateway computer 746 or application server 747 (which may access a data repository 748). A gateway computer 746 serves as a point of entry into each network, such as network 744. The gateway 746 may be preferably coupled to another network 742 by means of a communications link 750a. The gateway 746 may also be directly coupled to one or more workstations 711 using a communications link 750b, 750c, and/or may be indirectly coupled to such devices. The gateway computer 746 may be implemented utilizing an Enterprise Systems Architecture/3900 computer available from IBM. Depending on the application, a midrange computer, such as an iSeries®, System i™, and so forth may be employed. (“Enterprise Systems Architecture/390” and “iSeries” are registered trademarks, and “System i” is a trademark, of IBM in the United States, other countries, or both.)

The gateway computer 746 may also be coupled 749 to a storage device (such as data repository 748).

Those skilled in the art will appreciate that the gateway computer 746 may be located a great geographic distance from the network 742, and similarly, the devices 710, 711 may be located some distance from the networks 742 and 744, respectively. For example, the network 742 may be located in California, while the gateway 746 may be located in Texas, and one or more of the devices 710 may be located in Florida. The devices 710 may connect to the wireless network 742 using a networking protocol such as the Transmission Control Protocol/Internet Protocol (“TCP/IP”) over a number of alternative connection media, such as cellular phone, radio frequency networks, satellite networks, etc. The wireless network 742 preferably connects to the gateway 746 using a network connection 750a such as TCP or User Datagram Protocol (“UDP”) over IP, X.25, Frame Relay, Integrated Services Digital Network (“ISDN”), Public Switched Telephone Network (“PSTN”), etc. The workstations 711 may connect directly to the gateway 746 using dial connections 750b or 750c. Further, the wireless network 742 and network 744 may connect to one or more other networks (not shown), in an analogous manner to that depicted in FIG. 7.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or flash memory), a portable compact disc read-only memory (“CD-ROM”), DVD, an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++, or the like, and conventional procedural programming languages such as the “C” programming language or similar programming languages. The program code may execute as a stand-alone software package, and may execute partly on a user's computing device and partly on a remote computer. The remote computer may be connected to the user's computing device through any type of network, including a local area network (“LAN”), a wide area network (“WAN”), or through the Internet using an Internet Service Provider.

Aspects of the present invention are described above with reference to flow diagrams and/or block diagrams of methods, apparatus (systems), and computer program products according to embodiments of the invention. It will be understood that each flow or block of the flow diagrams and/or block diagrams, and combinations of flows or blocks in the flow diagrams and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram flow or flows and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram flow or flows and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flow diagram flow or flows and/or block diagram block or blocks.

Flow diagrams and/or block diagrams presented in the figures herein illustrate the architecture, functionality, and operation of possible implementations of systems, methods, and computer program products according to various embodiments of the present invention. In this regard, each flow or block in the flow diagrams or block diagrams may represent a module, segment, or portion of code, which comprises one or more executable instructions for implementing the specified logical function(s). It should also be noted that, in some alternative implementations, the functions noted in the flows and/or blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or each flow of the flow diagrams, and combinations of blocks in the block diagrams and/or flows in the flow diagrams, may be implemented by special purpose hardware-based systems that perform the specified functions or acts, or combinations of special purpose hardware and computer instructions.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of providing a user-specific search result, comprising:
responsive to receiving a search query from a user, performing a search of network-accessible documents using the search query to obtain a search result, the search result comprising an ordered sequence of identifications of a plurality of the network-accessible documents that match the search query; and
programmatically customizing the search result using a user-specific model for the user, the user-specific model comprising a set of keywords and relationships among the keywords, further comprising:
locating, in the model, a selected one of the keywords that corresponds to the search query;
obtaining, from the model, each of at least one of the keywords that has a relationship with the located keyword;
comparing each obtained keyword to the identifications to locate any of the identifications which match the each obtained keyword;
re-ranking the search result, based on the comparing, by changing an order of at least one of the identifications within the ordered sequence; and
rendering, for the user, the search result as re-ranked.

2. The method according to claim 1, further comprising grouping the identifications within the re-ranked search result according to the identifications that match each of the obtained at least one keyword, and wherein the rendering renders the search result as re-ranked and grouped.

3. The method according to claim 1, wherein the model further comprises, in association with each of the relationships, a bond strength value indicating a strength of a bond between the keywords in the relationship.

4. The method according to claim 3, wherein:
the located keyword has relationships with a plurality of other keywords in the model, such that the obtaining obtains a plurality of the keywords that have a relationship with the located keyword; and
the re-ranking further comprises:
determining, for each of the obtained keywords, the bond strength value associated with the relationship between the obtained keyword and the located keyword;
placing each of the identifications into a logical grouping that is associated with the obtained keyword to which the each identification matches; and
wherein changing the order of at least one of the identifications further comprises placing the logically-grouped identifications within the ordered sequence according to a decreasing magnitude of the bond strength values.

5. The method according to claim 1, wherein the model is programmatically constructed by programmatically evaluating a collection of data of a user to determine therefrom the keywords and the relationships.

6. The method according to claim 5, wherein the collection of data comprises at least one of: email messages stored for the user; instant messages stored for the user; text files stored for the user; video files stored for the user; and image files stored for the user.

7. The method according to claim 5, wherein the collection of data comprises content shared by the user, or received by the user, in at least one social networking channel.

8. The method according to claim 5, further comprising:
obtaining at least one user-specific priority criterion for the user; and
wherein:
the model further comprises, in association with each of the relationships, a bond strength value indicating a strength of a bond between the keywords in the relationship; and
the programmatically evaluating assigns a higher bond strength value to relationships according to the obtained at least one user-specific priority criterion.

9. The method according to claim 8, wherein at least one of the at least one user-specific priority criterion is based on an author of the data in the collection.

10. The method according to claim 8, wherein at least one of the at least one user-specific priority criterion is based on a type of the data in the collection.

11. The method according to claim 1, further comprising:
creating a hierarchical graphic comprising a first graphical element corresponding to the located keyword and an additional graphical element corresponding to each obtained keyword, wherein a positional relationship of the first graphical element to each additional graphical element in the hierarchical graphic reflects the relationship between the located keyword and each obtained keyword; and
rendering the hierarchical graphic with the search result as re-ranked, wherein the each additional graphical element of the rendered graphic is selectable by the user to position, at a highest order in the ordered sequence, ones of the identifications that match the obtained keyword to which the selected additional graphical element corresponds.

12. A system for providing a user-specific search result, comprising:
a computer comprising a processor; and
instructions which are executable, using the processor, to implement functions comprising:
responsive to receiving a search query from a user, performing a search of network-accessible documents using the search query to obtain a search result, the search result comprising an ordered sequence of identifications of a plurality of the network-accessible documents that match the search query; and
programmatically customizing the search result using a user-specific model for the user, the user-specific model comprising a set of keywords and relationships among the keywords, further comprising:
locating, in the model, a selected one of the keywords that corresponds to the search query;
obtaining, from the model, each of at least one of the keywords that has a relationship with the located keyword;
comparing each obtained keyword to the identifications to locate any of the identifications which match the each obtained keyword;
re-ranking the search result, based on the comparing, by changing an order of at least one of the identifications within the ordered sequence; and
rendering, for the user, the search result as re-ranked.

13. The system according to claim 12, wherein the functions further comprise grouping the identifications within the re-ranked search result according to the identifications that match each of the obtained at least one keyword, and wherein the rendering renders the search result as re-ranked and grouped.

14. The system according to claim 13, wherein:
the model further comprises, in association with each of the relationships, a bond strength value indicating a strength of a bond between the keywords in the relationship;
the located keyword has relationships with a plurality of other keywords in the model, such that the obtaining obtains a plurality of the keywords that have a relationship with the located keyword; and
the re-ranking further comprises:
determining, for each of the obtained keywords, the bond strength value associated with the relationship between the obtained keyword and the located keyword;
placing each of the identifications into a logical grouping that is associated with the obtained keyword to which the each identification matches; and
wherein changing the order of at least one of the identifications further comprises placing the logically-grouped identifications within the ordered sequence according to a decreasing magnitude of the bond strength values.

15. The system according to claim 12, wherein the functions further comprise:
creating a hierarchical graphic comprising a first graphical element corresponding to the located keyword and an additional graphical element corresponding to each obtained keyword, wherein a positional relationship of the first graphical element to each additional graphical element in the hierarchical graphic reflects the relationship between the located keyword and each obtained keyword; and
rendering the hierarchical graphic with the search result as re-ranked, wherein the each additional graphical element of the rendered graphic is selectable by the user to position, at a highest order in the ordered sequence, ones of the identifications that match the obtained keyword to which the selected additional graphical element corresponds.

16. A computer program product for providing a user-specific search result, the computer program product comprising:
a computer readable storage medium having computer readable program code embodied therein, the computer readable program code configured for:
responsive to receiving a search query from a user, performing a search of network-accessible documents using the search query to obtain a search result, the search result comprising an ordered sequence of identifications of a plurality of the network-accessible documents that match the search query; and
programmatically customizing the search result using a user-specific model for the user, the user-specific model comprising a set of keywords and relationships among the keywords, further comprising:
locating, in the model, a selected one of the keywords that corresponds to the search query;
obtaining, from the model, each of at least one of the keywords that has a relationship with the located keyword;
comparing each obtained keyword to the identifications to locate any of the identifications which match the each obtained keyword;
re-ranking the search result, based on the comparing, by changing an order of at least one of the identifications within the ordered sequence; and
rendering, for the user, the search result as re-ranked.

17. The computer program product according to claim 16, wherein the computer readable program code is further configured for grouping the identifications within the re-ranked search result according to the identifications that match each of the obtained at least one keyword, and wherein the rendering renders the search result as re-ranked and grouped.

18. The computer program product according to claim 17, wherein:
the model further comprises, in association with each of the relationships, a bond strength value indicating a strength of a bond between the keywords in the relationship;
the located keyword has relationships with a plurality of other keywords in the model, such that the obtaining obtains a plurality of the keywords that have a relationship with the located keyword; and
the re-ranking further comprises:
determining, for each of the obtained keywords, the bond strength value associated with the relationship between the obtained keyword and the located keyword;
placing each of the identifications into a logical grouping that is associated with the obtained keyword to which the each identification matches; and
wherein changing the order of at least one of the identifications further comprises placing the logically-grouped identifications within the ordered sequence according to a decreasing magnitude of the bond strength values.

19. The computer program product according to claim 16, wherein the computer readable program code is further configured for:
creating a hierarchical graphic comprising a first graphical element corresponding to the located keyword and an additional graphical element corresponding to each obtained keyword, wherein a positional relationship of the first graphical element to each additional graphical element in the hierarchical graphic reflects the relationship between the located keyword and each obtained keyword; and
rendering the hierarchical graphic with the search result as re-ranked, wherein the each additional graphical element of the rendered graphic is selectable by the user to position, at a highest order in the ordered sequence, ones of the identifications that match the obtained keyword to which the selected additional graphical element corresponds.
